(19) United States
(12) Patent Application Publication
(10) Pub. No.: US 2014/0363161 A1
(43) Pub. Date: Dec. 11, 2014

(54) OPTICAL SIGNAL SWITCHING DEVICE AND OPTICAL TRANSMISSION SYSTEM

(71) Applicant: FUJITSU LIMITED, Kawasaki-shi (JP)

(72) Inventors: YASUSHI OIKAWA, Yokohama (JP); Kenji Ota, Ota (JP)

(21) Appl. No.: 14/465,761

(22) Filed: Aug. 21, 2014

Related U.S. Application Data
(63) Continuation of application No. PCT/JP2012/054839, filed on Feb. 27, 2012.

(51) Int. Cl. H04Q 11/00; H04J 14/02

(52) U.S. Cl. CPC H04Q 11/0003; H04J 14/02
USPC 398/48

(57) ABSTRACT

An optical signal switching device includes: first through third input ports; first through third output ports; first through third optical splitters: first through third optical couplers; first through third short wavelength pass filters respectively configured to pass the first wavelength band; and first through third long wavelength pass filters respectively configured to pass the second wavelength band. Each of the optical splitters splits a WDM optical signal input through a corresponding input port to be guided to a corresponding short wavelength pass filter and a corresponding long wavelength pass filter. Each of the optical couplers combines an output optical signal of a corresponding short wavelength pass filter and an output signal of a corresponding long wavelength pass filter to be guided to a corresponding output port.

### CROSS-REFERENCE TO RELATED APPLICATIONS

This application is a continuation application of International Application PCT/JP2012/054839 filed on Feb. 27, 2012 and designated the U.S., the entire contents of which are incorporated herein by reference.

### FIELD

The embodiments discussed herein are related to an optical signal switching device and an optical transmission system.

### BACKGROUND

In an optical transmission system, an optical signal switching device which branches and drops an optical signal is used to communicate information among a plurality of locations. The optical signal switching device may guide an optical signal transmitted from an arbitrary location to another arbitrary location among three or more locations. In addition, the optical signal switching device may extract a part of a plurality of optical signals in a WDM optical signal on an optical transmission path and guide the extracted signal to a specified node.

FIG. 1 illustrates an example of a conventional optical signal switching device. An optical signal switching device 100 illustrated in FIG. 1 connects locations A, B, and C. In this example, a trunk transmission path is configured between the locations A and B. The location C is connected to the trunk transmission path through a branch transmission path. The optical signal switching device 100 includes an optical device which guides the optical signal on an input side trunk transmission path to an output side trunk transmission path and a branch transmission path, and an optical device which guides the optical signal in the branch transmission path to the output side trunk transmission path.

However, in the configuration, it is necessary to provide a set of branch transmission paths for transmitting an optical signal between the locations A and C, and a set of branch transmission path for transmitting an optical signal between the locations B and C. That is, in the configuration illustrated in FIG. 1, two sets of branch transmission paths are configured.

FIG. 2 illustrates an example of another example of a conventional optical signal switching device. An optical signal switching device 110 illustrated in FIG. 2 includes optical circulators E1 through E6 and optical filters F1 through F4 to connect the locations A, B, and C. In the following explanation, the optical signal of a wavelength λ1, the optical signal of a wavelength λ2, and the optical signal of a wavelength λ3 are respectively referred to as optical signal λ1, optical signal λ2, and optical signal λ3.

The optical transmission device at the location A transmits the optical signals λ1 and λ2. The optical circulator E1 guides the optical signals λ1 and λ2 to the optical filter F1. The optical filter F1 passes the optical signal λ2 and guides it to the optical circulator E2. The optical circulator E2 guides the optical signal λ2 to an optical transmission path connected to the location B. Thus, the optical signal λ2 transmitted from the location A is guided to the location B. Furthermore, the optical filter F1 reflects the optical signal λ1 which has been guided from the optical circulator E1. The optical signal λ1 which has been reflected by the optical filter F1 is guided to the optical filter F3 by the optical circulator E1. The optical filter F3 passes the optical signal λ1 and guides it to the optical circulator E5. The optical circulator E5 guides the optical signal λ1 to an optical transmission path which is connected to the location C. Thus, the optical signal λ1 transmitted from the location A is guided to the location C.

Similarly, the optical signal switching device 110 guides the optical signals λ2 and λ3 which have been transmitted from the location B to the locations A and C respectively. Furthermore, the optical signal switching device 110 guides the optical signals λ1 and λ3 which have been transmitted from the location C to the locations A and B respectively.

According to the configuration illustrated in FIG. 2, a set of optical transmission paths are respectively provided between the optical signal switching device 110 and each of the locations A and C. That is, the configuration illustrated in FIG. 2 may transmit optical signals between the locations A and C using the smaller number of optical transmission paths comparing with the configuration illustrated in FIG. 1.

The technology related to the configuration illustrated in FIG. 2 is described in, for example, Japanese Laid-open Patent Publication No. 9-153861. Japanese Laid-open Patent Publication No. 9-289491 describes another related technology.

In the conventional configuration, the utilization efficiency of communication resources (the wavelength in this example) is low. For example, in the example illustrated in FIG. 2, three wavelengths λ1 through λ3 are required to transmit optical signals among the locations A through C. This problem also occurs in the case in which WDM transmission band is allocated.

For example, assume that the bandwidth for a WDM transmission is 36 nm, and that a band is equally allocated to the locations A through C. In this case, the bandwidth allocated to each of the communications between the locations A and B, between the locations B and C, and between the locations C and A is 12 nm at maximum.

### SUMMARY

According to an aspect of the embodiments, an optical signal switching device used in an optical transmission system which transmits a WDM optical signal including a first wavelength band and a second wavelength band which is allocated at a longer wavelength side with respect to the first wavelength band, includes: first through third input ports; first through third output ports; first through third optical splitters: first through third optical couplers; first through third short wavelength pass filters respectively configured to pass the first wavelength band and reject the second wavelength band; and first through third long wavelength pass filters respectively configured to pass the second wavelength band and reject the first wavelength band. The first optical splitter splits a WDM optical signal input through the first input port to be guided to the first short wavelength pass filter and the first long wavelength pass filter. The second optical splitter splits a WDM optical signal input through the second input port to be guided to the second short wavelength pass filter and the second long wavelength pass filter. The third optical splitter splits a WDM optical signal input through the third input port to be guided to the third short wavelength pass filter and the third long wavelength pass filter. The first optical coupler combines an output optical signal of the first short wavelength pass filter and an output signal of the third long wavelength pass filter to be guided to the second output port. The second optical coupler combines an output optical signal of the second short wavelength pass filter and an output signal of the first long wavelength pass filter to be guided to the third output port. The third optical coupler combines an output optical signal of the third short wavelength pass filter and an output signal of the second long wavelength pass filter to be guided to the first output port.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a conventional optical signal switching device;

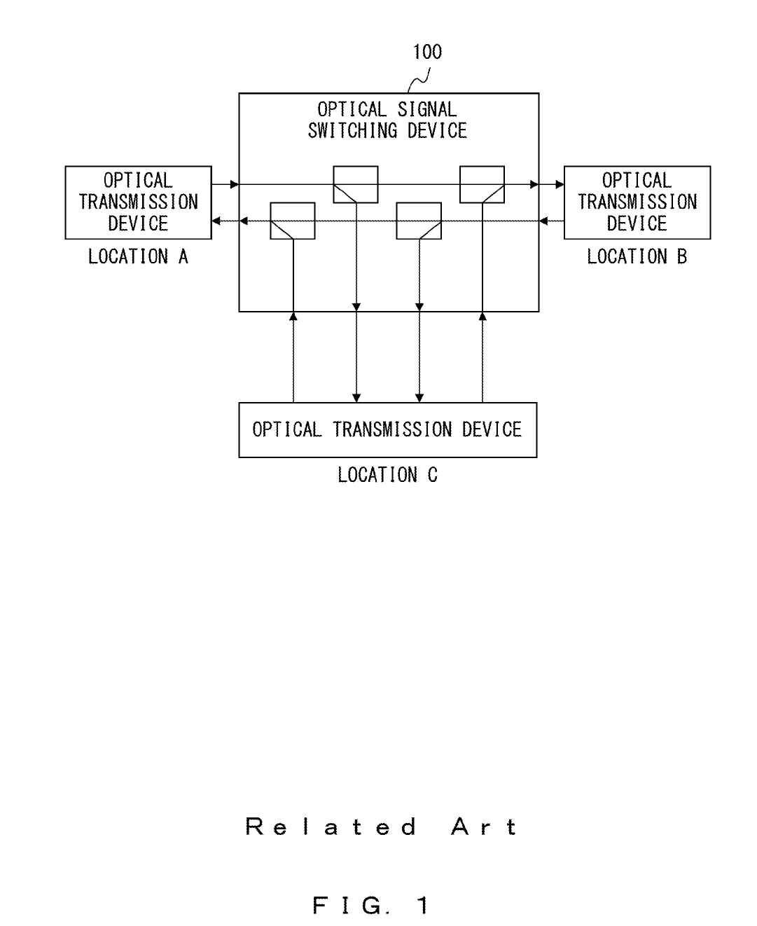

FIG. 2 illustrates another example of a conventional optical signal switching device;

FIG. 3 illustrates an example of an optical transmission system in which an optical signal switching device according to an embodiment of the present invention is used;

FIG. 4 illustrates the wavelength allocation for a WDM signal;

FIG. 5 illustrates an example of a configuration of an optical transmission device;

FIG. 6 illustrates an example of a submarine cable system;

FIG. 7 is an explanatory view of the configuration and the operation of the optical signal switching device according to an embodiment of the present invention; and

FIG. 8 is an explanatory view of the configuration and the operation of the optical signal switching device according to another embodiment of the present invention.

### DESCRIPTION OF EMBODIMENTS

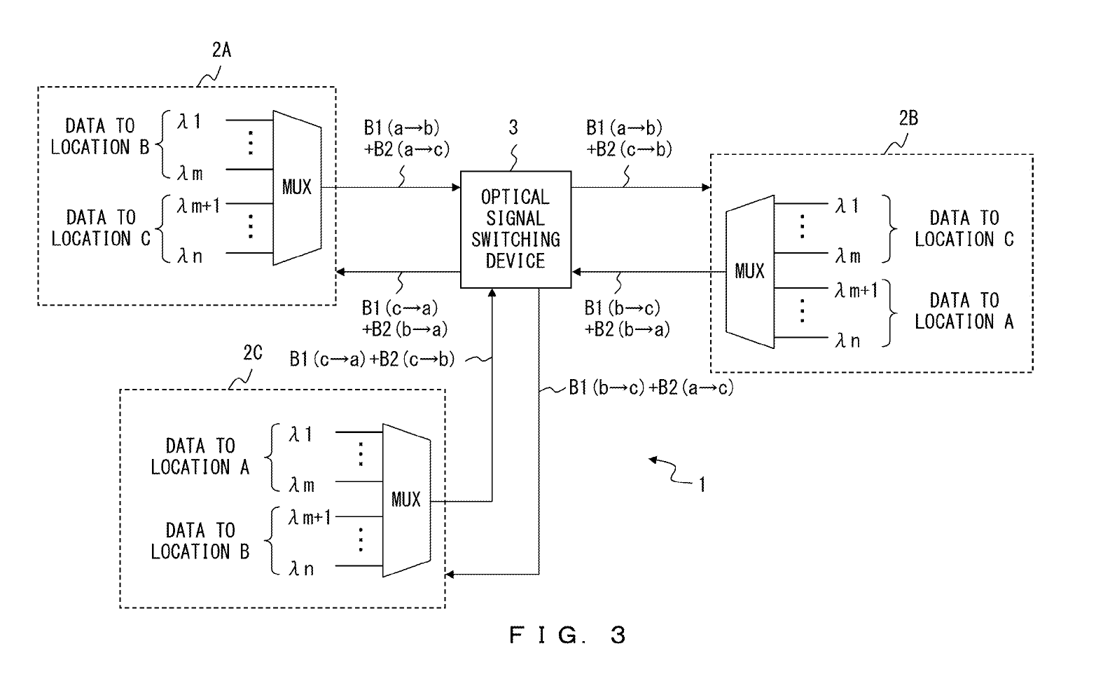

FIG. 3 illustrates an example of an optical transmission system in which an optical signal switching device according to an embodiment of the present invention is used. An optical transmission system 1 illustrated in FIG. 3 includes optical transmission devices 2A, 2B, and 2C and an optical signal switching device 3. The optical transmission devices 2A, 2B, and 2C are respectively provided at the locations A, B, and C.

The optical transmission system 1 transmits a WDM optical signal through an optical transmission path. That is, each of the optical transmission devices 2A through 2C may transmit and receive a WDM optical signal. The WDM optical signal may transmit a plurality of optical signals using the wavelengths λ1 through λn in a wavelength band BW. The wavelengths λ1 through λn are allocated, for example, at specified spacing. In the following explanation, the optical signals of wavelengths λ1 through λn may be referred to as optical signals λ1 through λn, respectively.

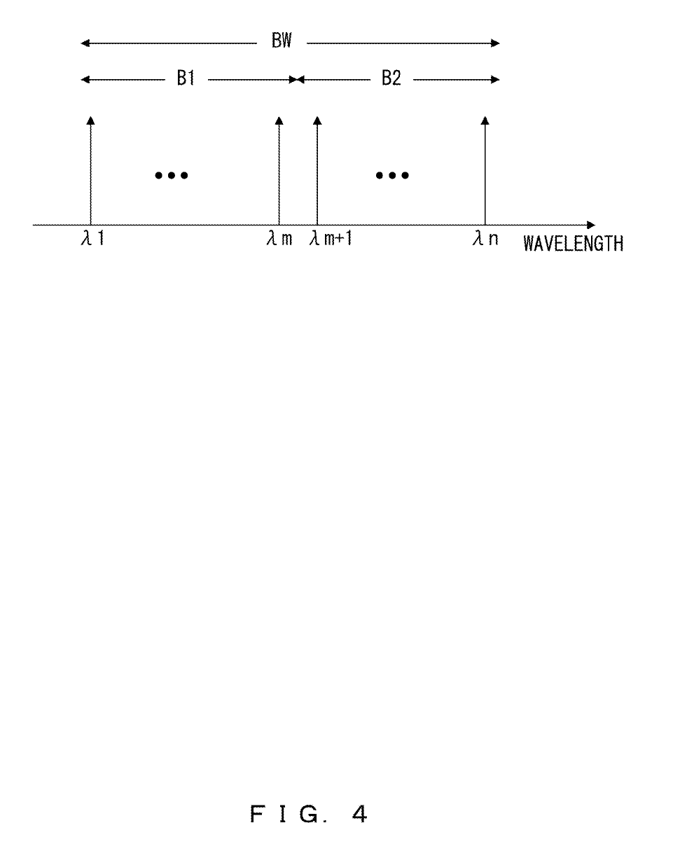

The optical transmission device 2A allocates the data to be transmitted to the optical transmission device 2B to the wavelengths λ1 through λm. That is, the optical transmission device 2A may transmit data to the optical transmission device 2B using the optical signals λ1 through λm. The optical transmission device 2A also allocates the data to be transmitted to the optical transmission device 2C to the wavelengths λm+1 through λn. That is, the optical transmission device 2A may transmit data to the optical transmission device 2C using the optical signals λm+1 through λn. The wavelengths λ1 through λm belong to a wavelength band B1 of the WDM optical signal as illustrated in FIG. 4. The wavelengths λm+1 through λn belong to a wavelength band B2 of the WDM optical signal. In this example, the wavelength band B2 is allocated to the longer wavelength side with respect to the wavelength band B1.

Thus, the optical transmission device 2A transmits data to the optical transmission device 2B using the wavelength band B1, and transmits data to the optical transmission device 2C using the wavelength band B2. That is, the optical transmission device 2A transmits a WDM optical signal in which an optical signal addressed to the optical transmission device 2B is allocated in the wavelength band B1, and an optical signal addressed to the optical transmission device 2C is allocated in the wavelength band B2. Therefore, in the WDM optical signal transmitted from the optical transmission device 2A, an optical signal addressed to the optical transmission device 2B is allocated in the wavelength band B1, and an optical signal addressed to the optical transmission device 2C is allocated in the wavelength band B2.

In FIG. 3 and the following explanation, “a→b” refers to the transmission from the optical transmission device 2A to the optical transmission device 2B. For example, B1 (a→b) refers to the wavelength band B1 including the optical signal transmitted from the optical transmission device 2A to the optical transmission device 2B. Similarly, “b→a” refers to the transmission from the optical transmission device 2B to the optical transmission device 2A, “a→c” refers to the transmission from the optical transmission device 2A to the optical transmission device 2C, “c→a” refers to the transmission from the optical transmission device 2C to the optical transmission device 2A, “b→c” refers to the transmission from the optical transmission device 2B to the optical transmission device 2C, and “c→b” refers to the transmission from the optical transmission device 2C to the optical transmission device 2B.

The optical transmission device 2B transmits data to the optical transmission device 2C using the wavelength band B1, and transmits data to the optical transmission device 2A using the wavelength band B2. That is, the optical transmission device 2B transmits a WDM optical signal in which an optical signal addressed to the optical transmission device 2C is allocated in the wavelength band B1, and an optical signal addressed to the optical transmission device 2A is allocated in the wavelength band B2. Therefore, in the WDM optical signal to be transmitted from the optical transmission device 2B, an optical signal addressed to the optical transmission device 2C is allocated in the wavelength band B1, and an optical signal addressed to the optical transmission device 2A is allocated in the wavelength band B2.

Similarly, the optical transmission device 2C transmits data to the optical transmission device 2A using the wavelength band B1, and transmits data to the optical transmission device 2B using the wavelength band B2. That is, the optical transmission device 2C transmits a WDM optical signal in which an optical signal addressed to the optical transmission device 2A is allocated in the wavelength band B1, and an optical signal addressed to the optical transmission device 2B is allocated in the wavelength band B2. Therefore, in the WDM optical signal to be transmitted from the optical transmission device 2C, an optical signal addressed to the optical transmission device 2A is allocated in the wavelength band B1, and an optical signal addressed to the optical transmission device 2B is allocated in the wavelength band B2.

The WDM optical signal transmitted from each of the optical transmission devices 2A through 2C is transmitted through an optical transmission path, and guided to the optical signal switching device 3. Each of the optical transmission devices 2A through 2C receives a WDM optical signal from the optical signal switching device 3.

Thus, in the optical transmission system 1 according to an embodiment of the present invention, the wavelength band for transmitting data to a correspondent device is different from the wavelength band for receiving data from the correspondent device. For example, when the optical transmission devices 2A and 2B are interested, data is transmitted from the optical transmission device 2A to the optical transmission device 2B using the wavelength band B1, and data is transmitted from the optical transmission device 2B to the optical transmission device 2A using the wavelength band B2. Similar band allocations are applied to other pairs of optical transmission devices.

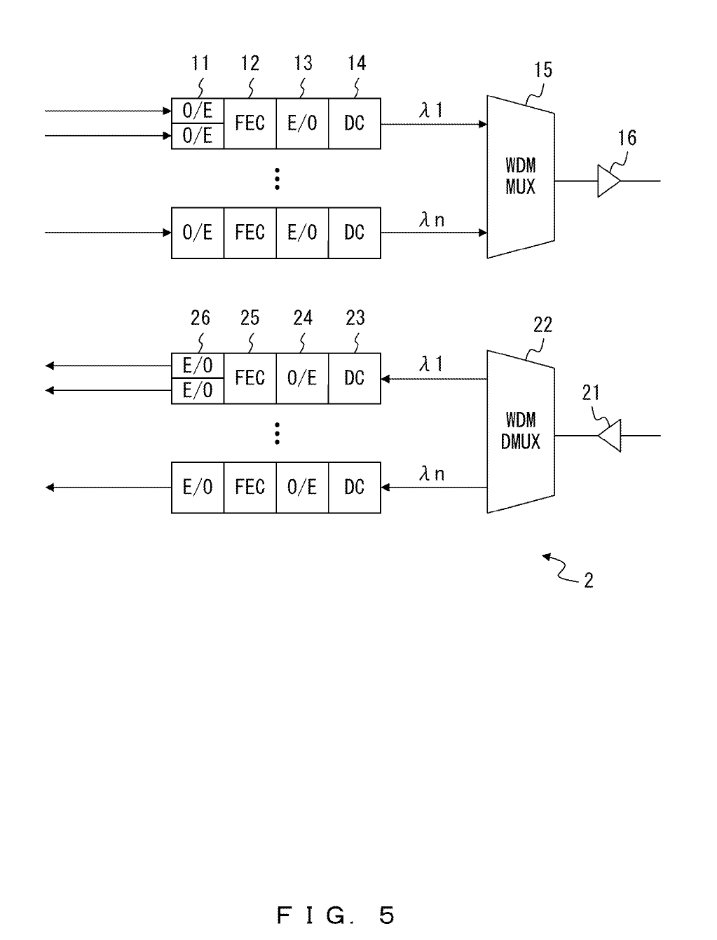

FIG. 5 illustrates an example of a configuration of an optical transmission device. The optical transmission device 2 illustrated in FIG. 5 is an example of the optical transmission devices 2A through 2C illustrated in FIG. 3.

The optical transmission device 2 includes a transmitter module and a receiver module. The transmitter module includes for each wavelength (λ1 through λn) an O/E unit 11, a signal processing unit (FEC) 12, an E/O unit 13, and a dispersion compensator (DC) 14. The O/E unit 11 converts an input optical signal into an electric signal. The input optical signal is generated by, for example, a local device or a client. When a plurality of input optical signals are converted into electric signals, the O/E unit 11 includes a plurality of OE elements. The signal processing unit 12 performs a specified process on the output signal of the O/E unit 11. In this case, the signal processing unit 12 may assign an error correction code to a data string. The E/O unit 13 converts the output signal of the E/O unit 13 into an optical signal. The dispersion compensator 14 is, for example, a dispersion compensating fiber, and compensates for the wavelength dispersion of the optical transmission path. The WDM multiplexer 15 multiplexes the optical signals λ1 through λn and generates a WDM optical signal. The optical amplifier 16 amplifies the WDM optical signal output from the WDM multiplexer 15.

In a receiver module, an optical amplifier 21 amplifies a WDM optical signal received through an optical transmission path. A WDM demultiplexer 22 demultiplexes the received WDM optical signal for each wavelength. The receiver module includes for each wavelength a dispersion compensator 23, an O/E unit 24, a signal processing unit (FEC) 25, and an E/O unit 26. The dispersion compensator 23 is, for example, a dispersion compensating fiber, and compensates for the wavelength dispersion of the optical transmission path. The O/E unit 24 converts the output signal of the dispersion compensator 23 into an electric signal. The signal processing unit 25 terminates the output signal of the O/E unit 24. In this case, the signal processing unit 25 may perform an error correcting process. The E/O unit 26 converts the output signal of the signal processing unit 25 into an optical signal. The optical signal output from the E/O unit 26 is guided to a corresponding local device or a client. When a signal is transmitted to a plurality of local devices or clients, the E/O unit 26 includes a plurality of E/O elements.

Thus, the optical transmission device 2 includes a transmitter module which transmits a WDM optical signal and a receiver module which receives a WDM optical signal. However, the configuration illustrated in FIG. 5 is an example, and the optical transmission system 1 and the optical signal switching device 3 do not depend on the configuration of the optical transmission device 2.

The optical transmission system 1 illustrated in FIG. 3 is applied to, for example, a submarine cable system. The submarine cable system includes, for example, landing stations 4A through 4C and submarine cables 5 laid between the landing stations. Each of the landing stations 4A through 4C includes an optical transmission device. Each of the landing stations 4A through 4C may include a power supply device, a submarine system monitor device, a cable terminator, a network switch device, an SDH connection device, a network monitor device, etc.

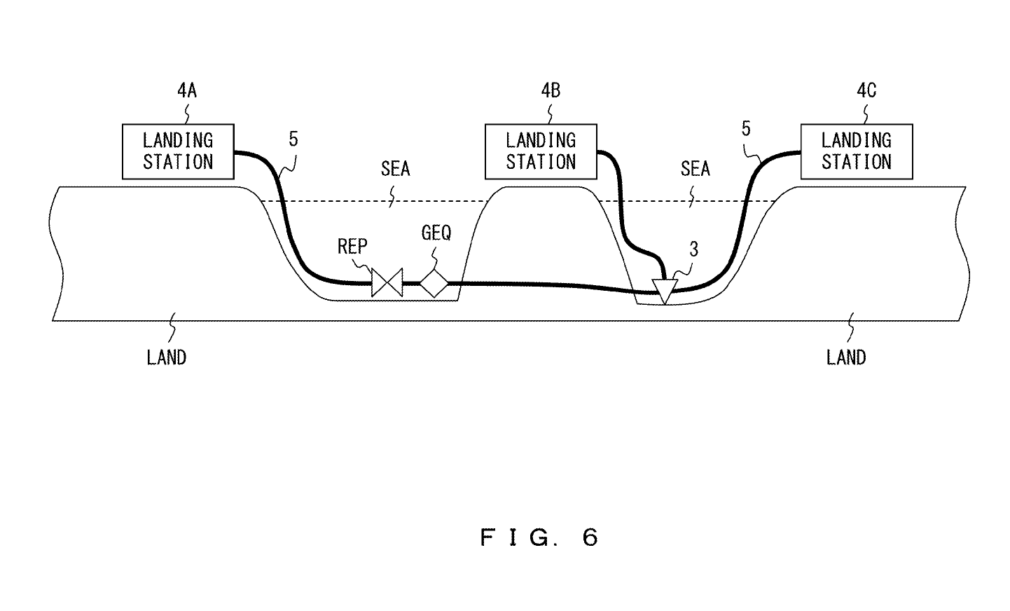

The submarine cable system includes an optical signal switching device 3. The optical signal switching device 3 may drop a part of a plurality of optical signals included in the WDM optical signal transmitted through a submarine cable. For example, the optical signal switching device 3 may drop a part of the plurality of optical signals included in the WDM optical signal transmitted from the landing station 4A, guide the part of the dropped signals to the landing station 4B, and guide the other optical signals to the landing station 4C. The optical signal switching device 3 is laid at the bottom of the sea in the example illustrated in FIG. 6.

The submarine cable system may include an optical amplification repeater (REP) which amplifies a WDM optical signal. Furthermore, the submarine cable system may also include a gain equalizer (GEQ) which equalizes the power of a plurality of optical signals included in the WDM optical signal.

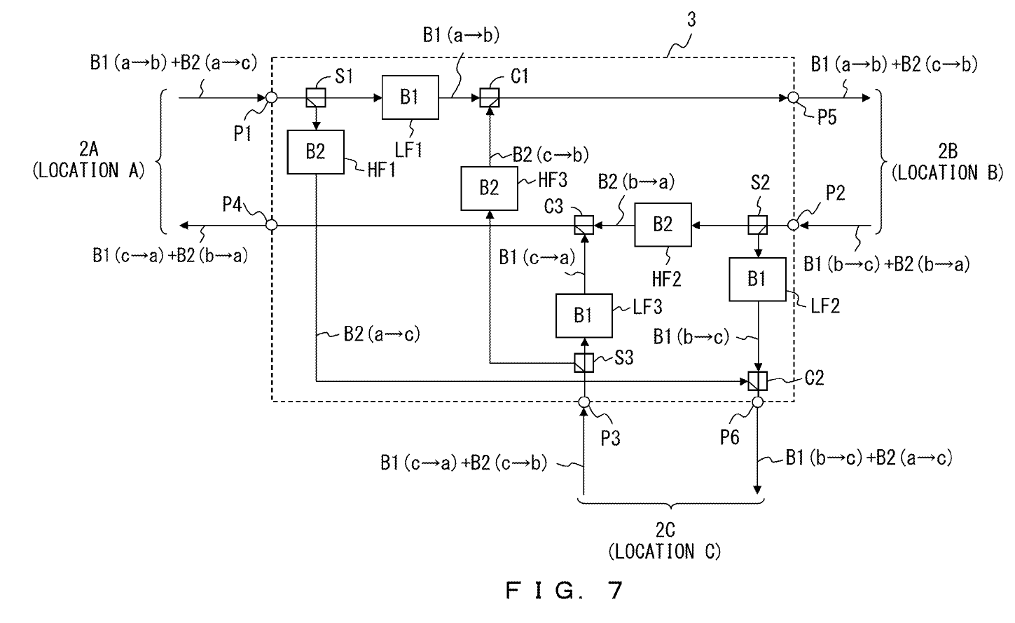

FIG. 7 is an explanatory view of the configuration and the operation of the optical signal switching device 3 according to an embodiment of the present invention. Assume that the optical signal switching device 3 is used in the optical transmission system 1 illustrated in FIG. 3.

The optical signal switching device 3 includes ports P1 through P6. The ports P1 through P3 are used as optical input ports. The ports P4 through P6 are used as optical output ports. The optical signal switching device 3 also includes optical splitters S1 through S3, optical couplers C1 through C3, optical filters LF1 through LF3, and optical filters HF1 through HF3.

Each of the optical splitters S1 through S3 splits input light. The split ratio is not specifically restricted, but maybe 1:1, for example. Furthermore, each of the optical splitters S1 through S3 may be implemented by, for example, an optical coupler.

Each of the optical couplers C1 through C3 combines input optical signals. Furthermore, each of the optical couplers C1 through C3 may be implemented by, for example, a WDM coupler.

Each of the optical filters LF1 through LF3 passes a shorter wavelength in the wavelength band of a WDM optical signal. That is, each of the optical filters LF1 through LF3 maybe implemented by a low pass filter. In the example, each of the optical filters LF1 through LF3 passes the wavelength band B1 (λ1 through λm) illustrated in FIG. 4, and rejects the wavelength band B2 (λm+1 through λn). Note that in FIG. 7, “B1” expressed for each of the optical filters LF1 through LF3 refers to a pass wavelength band.

Each of the optical filters HF1 through HF3 passes a longer wavelength in the wavelength band of a WDM optical signal. That is, each of the optical filters HF1 through HF3 maybe implemented by a high pass filter. In the example, each of the optical filters HF1 through HF3 passes the wavelength band B2 (λm+1 through λn) illustrated in FIG. 4, and rejects the wavelength band B1 (λ1 through λm). Note that in FIG. 7, “B2” expressed for each of the optical filters HF1 through HF3 refers to a pass wavelength band.

The optical filters LF1 through LF3 and the optical filters HF1 through HF3 are implemented by optical filters which have a wavelength dependent characteristic that passes, rejects, or attenuates a particular wavelength (or wavelength band). For example, the optical filters LF1 through LF3 and the optical filters HF1 through HF3 may be implemented by fiber Bragg grating (FBG) or a dielectric multilayer.

The port P1 is optically connected to the optical transmission path between the optical transmission device 2A provided at the location A and the optical signal switching device 3. The optical signal switching device 3 receives a

WDM. optical signal including the wavelength band B1 (a→b) and the wavelength band B2 (a→c) through the port P1. The port P2 is optically connected to the optical transmission path between the optical transmission device 2B provided at the location B and the optical signal switching device 3. The optical signal switching device 3 receives a WDM optical signal including the wavelength band B1 (b→c) and the wavelength band B2 (b→a) through the port P2. The port P3 is optically connected to the optical transmission path between the optical transmission device 2C provided at the location C and the optical signal switching device 3. The optical signal switching device 3 receives a WDM optical signal including the wavelength band B1 (c→a) and the wavelength band B2 (c→b) through the port P3.

The optical splitter S1 guides the WDM optical signal received through the port P1 to the optical filter LF1 and the optical filter HF1. That is, the WDM optical signal including the wavelength band B1 (a→b) and the wavelength band B2 (a→c) is guided to both of the optical filter LF1 and the optical filter HF1.

The optical filter LF1 passes the wavelength band B1 and rejects the wavelength band B2 as described above.

Therefore, the optical filter LF1 passes the wavelength band B1 (a→b), and rejects the wavelength band B2 (a→c). Accordingly, the wavelength band B1 (a→b) is guided from the optical filter LF1 to the optical coupler C1.

The optical filter HF1 passes the wavelength band

B2 and rejects the wavelength band B1 as described above. Therefore, the optical filter HF1 passes the wavelength band B2 (a→c), and rejects the wavelength band B1 (a→b). Accordingly, the wavelength band B2 (a→c) is guided from the optical filter HF1 to the optical coupler C2.

The optical splitter S2 guides the WDM optical signal received through the port P2 to the optical filter LF2 and the optical filter HF2. That is, the WDM optical signal including the wavelength band B1 (b→c) and the wavelength band B2 (b→a) is guided to both of the optical filter LF2 and the optical filter HF2.

The optical filter LF2 passes the wavelength band B1 and rejects the wavelength band B2 as described above. Therefore, the optical filter LF2 passes the wavelength band B1 (b→c), and rejects the wavelength band B2 (b→a). Accordingly, the wavelength band B1 (b→c) is guided from the optical filter LF2 to the optical coupler C2.

The optical filter HF2 passes the wavelength band B2 and rejects the wavelength band B1. That is, the optical filter HF2 passes the wavelength band B2 (b→a), and rejects the wavelength band B1 (b→c). Accordingly, the wavelength band B2 (b→a) is guided from the optical filter HF2 to the optical coupler C3.

The optical splitter S3 guides the WDM optical signal received through the port P3 to the optical filter LF3 and the optical filter HF3. That is, the WDM optical signal including the wavelength band B1 (c→a) and the wavelength band B2 (c→b) is guided to both of the optical filter LF3 and the optical filter HF3.

The optical filter LF3 passes the wavelength band B1 and rejects the wavelength band B2. That is, the optical filter LF3 passes the wavelength band B1 (c→a), and rejects the wavelength band B2 (c→b). Accordingly, the wavelength band B1 (c→a) is guided from the optical filter LF3 to the optical coupler C3.

The optical filter HF3 passes the wavelength band B2 and rejects the wavelength band B1. That is, the optical filter HF3 passes the wavelength band B2(c→b), and rejects the wavelength band B1 (c→a). Accordingly, the wavelength band B2 (c→b) is guided from the optical filter HF3 to the optical coupler C1.

The wavelength band B1 (a→b) output from the optical filter LF1 and the wavelength band B2 (c→b) output from the optical filter HF3 are guided to the optical coupler C1. The optical coupler C1 combines the wavelength band B1 (a→b) and the wavelength band B2 (c→b). The output light of the optical coupler C1 is guided to the port P5. Therefore, the WDM optical signal including the wavelength band B1 (a→b) and the wavelength band B2 (c→b) is output through the port P5, and transmitted to the optical transmission device 2B provided at the location B. Note that the port P5 is optically connected to the optical transmission path between the optical signal switching device 3 and the optical transmission device 2B provided at the location B.

The wavelength band B1 (b→c) output from the optical filter LF2 and the wavelength band B2 (a→c) output from the optical filter HF1 are guided to the optical coupler C2. The optical coupler C2 combines the wavelength band B1 (b→c) and the wavelength band B2 (a→c). The output light of the optical coupler C2 is guided to the port P6. Therefore, the WDM optical signal including the wavelength band B1 (b→c) and the wavelength band B2 (a→c) is output through the port P6, and transmitted to the optical transmission device 2C provided at the location C. Note that the port P6 is optically connected to the optical transmission path between the optical signal switching device 3 and the optical transmission device 2C provided at the location C.

The wavelength band B1 (c→a) output from the optical filter LF3 and the wavelength band B2 (b→a) output from the optical filter HF2 are guided to the optical coupler C3. The optical coupler C1 combines the wavelength band B1 (c→a) and the wavelength band B2 (b→a). The output light of the optical coupler C3 is guided to the port P4. Therefore, the WDM optical signal including the wavelength band B1 (c→a) and the wavelength band B2 (b→a) is output through the port P4, and transmitted to the optical transmission device 2A provided at the location A. Note that the port P4 is optically connected to the optical transmission path between the optical signal switching device 3 and the optical transmission device 2A provided at the location A.

Thus, the optical signal switching device 3 separates the WDM optical signal received from the location A into the wavelength band B1 and the wavelength band B2, transmits the optical signal in the wavelength band B1 to the location B, and transmits the optical signal in the wavelength band B2 to the location C. The optical signal switching device 3 also separates the WDM optical signal received from the location B into the wavelength band B1 and the wavelength band B2, transmits the optical signal in the wavelength band B1 to the location C, and transmits the optical signal in the wavelength band B2 to the location A. Furthermore, the optical signal switching device 3 separates the WDM optical signal received from the location C into the wavelength band B1 and the wavelength band B2, transmits the optical signal in the wavelength band B1 to the location A, and transmits the optical signal in the wavelength band B2 to the location B.

The optical signal switching device 3 illustrated in FIG. 7 is used in the optical transmission system which transmits WDM optical signals among the three locations A through C. However, the present invention is not limited to this configuration. That is, the optical signal switching device according to the embodiment of the present invention maybe used in an optical transmission system which transmits WDM optical signals four or more locations.

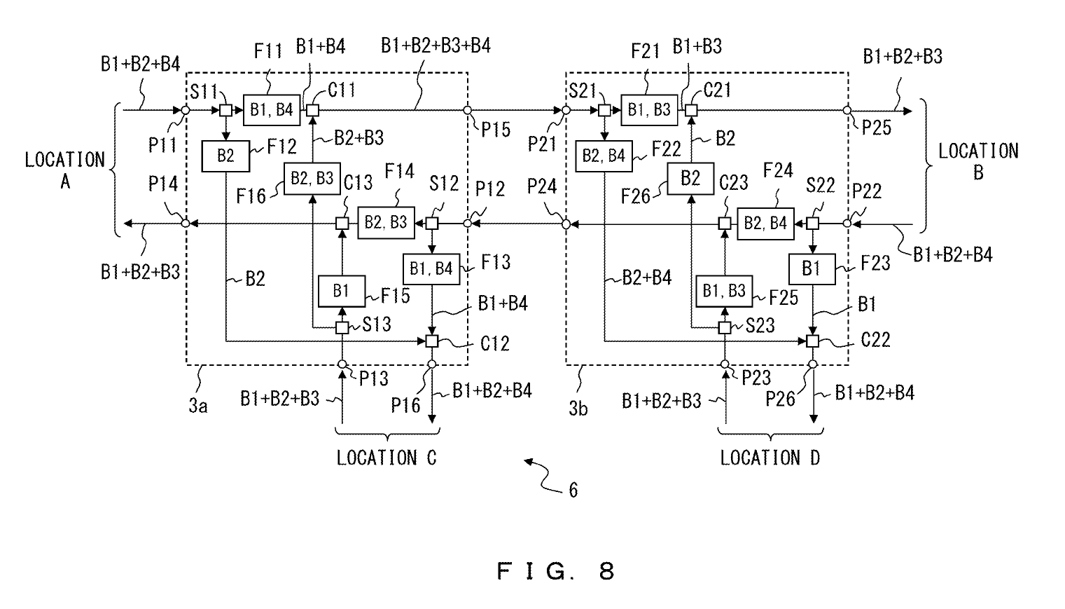

FIG. 8 is a configuration of the optical signal switching device used in an optical transmission system which transmits WDM optical signals four locations. An optical signal switching device 6 includes two transmission modules 3a and 3b. Each of the transmission modules 3a and 3b has a configuration similar to the configuration of the optical signal switching device 3. The feature of each optical filter in the transmission modules 3a and 3b may be different from those of the optical filters LF1 through LF3, and HF1 through HF3.

In the following explanation, it is assumed that the optical transmission devices 2A through 2D are respectively provided at the locations A through D. Each of the optical transmission devices 2A through 2D generates and transmits the following WDM optical signal. The wavelength band BW of the WDM optical signal is divided into four wavelength bands B1 through B4.

Optical transmission device 2A: B1 (a→b)+B2 (a→c)+B4 (a→d)
Optical transmission device 2B: B1 (b→d)+B2 (b→a)+B4 (b→c)
Optical transmission device 2C: B1 (c→a)+B2 (c→d)+B3 (c→b)
Optical transmission device 2D: B1 (d→c)+B2 (d→b)+B3 (d→a)

In addition, for the communication in any pair of optical transmission devices, the wavelengths (or wavelength bands) bidirectionally transmitted are different from each other. For example, the wavelength band B4 is allocated to the signal transmitted from the optical transmission device 2A to the optical transmission device 2D, and the wavelength band B3 is allocated to the signal transmitted from the optical transmission device 2D to the optical transmission device 2A.

The transmission module 3a includes the ports P11 through P16, the optical splitters S11 through S13, the optical couplers C11 through C13, and the optical filters F11 through F16. The transmission module 3b includes the ports P21 through P26, the optical splitters S21 through S23, the optical couplers C21 through S23, and the optical filters F21 through F26.

The ports P11 and P14 are optically connected to the optical transmission paths between the optical signal switching device 3 and the optical transmission device 2A provided at the location A. The ports P13 and P16 are optically connected to the optical transmission paths between the optical signal switching device 3 and the optical transmission device 2C provided at the location C. The ports P22 and P25 are optically connected to the optical transmission paths between the optical signal switching device 3 and the optical transmission device 2B provided at the location B. The ports P23 and P26 are optically connected to the optical transmission path between the optical signal switching device 3 and the optical transmission device 2D provided at the location D.

The ports P12 and P15 of the transmission module 3a are optically connected respectively to the ports P24 and P21 of the transmission module 3b. That is, a set of the optical input port and the optical output port of the transmission module 3a are optically connected to the corresponding set of the optical output port and the optical input port of the transmission module 3b.

Each of the optical filters F11 through F16 and F21 through F26 has a wavelength characteristic determined depending on the wavelength allocation in the optical transmission system. The wavelength characteristic of each of the optical filters F11 through F16 and F21 through F26 is illustrated in FIG. 8. In FIG. 8, the reference numerals B1 through B4 assigned to the optical filters F11 through F16 and F21 through F26 refer to the pass wavelength bands. For example, “B1, B4” are assigned to the optical filter F11. This description indicates that the optical filter F11 passes the wavelength band B1 and the wavelength band B4, and rejects other wavelengths. Similarly, “B2” is assigned to the optical filter F12. This description indicates that the optical filter F12 passes the wavelength band B2, and rejects other wavelengths.

The operation of the optical signal switching device 6 with the above-mentioned configuration is described below. Described below is the WDM optical signal transmitted from the optical transmission device 2A provided at the location A. This WDM optical signal is input through the port P11 and guided to the optical splitter S11.

The optical splitter S11 guides the input WDM optical signal to the optical filters F11 and F12. That is, the WDM optical signal including B1 (a→b), B2 (a→c), and B4 (a→d) is guided to both of the optical filters F11 and F12.

The optical filter F11 passes the wavelength bands B1 and B4, but rejects the wavelength bands B2 and B3 as illustrated in FIG. 8. Therefore, the optical filter F11 passes the B1 (a→b) and B4 (a→d), but rejects B2 (a→c). The optical signals of B1 (a→b) and the optical signal of B4 (a→d) output from the optical filter F11 are guided to the optical splitter S21 through the optical coupler C11 and the ports P15 and P21.

The optical splitter S21 guides the input light to the optical filters F21 and F22. That is, the WDM optical signal including B1 (a→b) and B4 (a→d) is guided to both of the optical filters F21 and F22. Note that the WDM optical signal also includes the wavelength bands B2 and B3 that are guided from the optical filter F16, as illustrated in FIG. 8.

The optical filter F21 passes the wavelength bands B1 and B3, but rejects the wavelength bands B2 and B4 as illustrated in FIG. 8. Therefore, the optical filter F21 passes at least B1 (a→b). Then, the optical signal of B1 (a→b) output from the optical filter F21 is transmitted to the optical transmission device 2B provided at the location B through the optical coupler C21 and the port P25. Note that the WDM optical signal transmitted via the port P25 includes not only B1 (a→b), but also B2 (d→b) and B3 (c→b).

The optical filter F22 passes the wavelength bands B2 and B4, but rejects the wavelength bands B1 and B3 as illustrated in FIG. 8. Therefore, the optical filter F22 passes at least B4 (a→d). Then, the optical signal of B4 (a→d) output from the optical filter F22 is transmitted to the optical transmission device 2D provided at the location D through the optical coupler C22 and the port P26. Note that the WDM optical signal transmitted via the port P26 includes not only B4 (a→d), but also B1 (b→d) and B2 (c→d).

The optical filter F12 passes the wavelength band B2, but rejects the wavelength bands B1, B3 and B4 as illustrated in FIG. 8. Therefore, the optical filter F12 passes at least B2 (a→c). Then, the optical signal of B2 (a→c) output from the optical filter F12 is transmitted to the optical transmission device 2C provided at the location C through the optical coupler C12 and the port P16. Note that the WDM optical signal transmitted via the port P16 includes not only B2 (a→c), but also B1 (d→c) and B4 (b→c).

Thus, upon receipt of the WDM optical signal illustrated in FIG. 8 from the location A, the optical signal switching device 6 guides the optical signal of the wavelength band B1, the optical signal of the wavelength band B2, and the optical signal of the wavelength band B4 included in the received WDM optical signal respectively to the locations B,

C, and D. Although omitted in the explanation, a similar transmitting operation is applied to the WDM optical signal transmitted from other locations (B, C, and D) to the optical signal switching device 6. Therefore, with the configuration illustrated in FIG. 8, data may be transmitted and received between optional optical transmission devices in the optical transmission system provided with respective optical transmission devices at four locations.

The optical signal switching device 6 illustrated in FIG. 8 is used in the optical transmission system which transmits WDM optical signals among four locations A through D. However, the optical signal switching device according to the embodiment of the present invention may also be used in the optical transmission system which transmits WDM optical signals among not less than five locations by increasing the number of transmission modules. For example, in the optical transmission system which transmits the WDM optical signal among five locations, the optical signal switching device includes three transmission modules. In the optical transmission system which transmits the WDM optical signal among six locations, the optical signal switching device includes four transmission modules.

However, the wavelength bands allocated to correspondent optical transmission devices, and the wavelength characteristic of each optical filter in each transmission module are appropriately determined depending on the number of locations. For example, in the optical transmission system which transmits optical signals among five locations, the wavelength allocation of the WDM optical signal which is transmitted from each of the locations A through E is described below.

Location A: B1 (a→b)+B2 (a→c)+B4 (a→d)+B3 (a→e)
Location B: B2 (b→a)+B5 (b→c)+B3 (b→d)+B1 (b→e)
Location C: B1 (c→a)+B6 (c→b)+B2 (c→d)+B5 (c→e)
Location D: B3 (d→a)+B4 (d→b)+B1 (d→c)+B2 (d→e)
Location E: B4 (e→a)+B2 (e→b)+B6 (e→c)+B1 (e→d)

Also in this case, for the communication in any pair of optical transmission devices, the wavelengths (or wavelength bands) bidirectionally transmitted are different from each other. For example, the wavelength band B3 is allocated to the signal transmitted from the location A to the location E, and the wavelength band B4 is allocated to the signal transmitted from the location E to the location A.

### <Effect by the Configuration of the Embodiment>

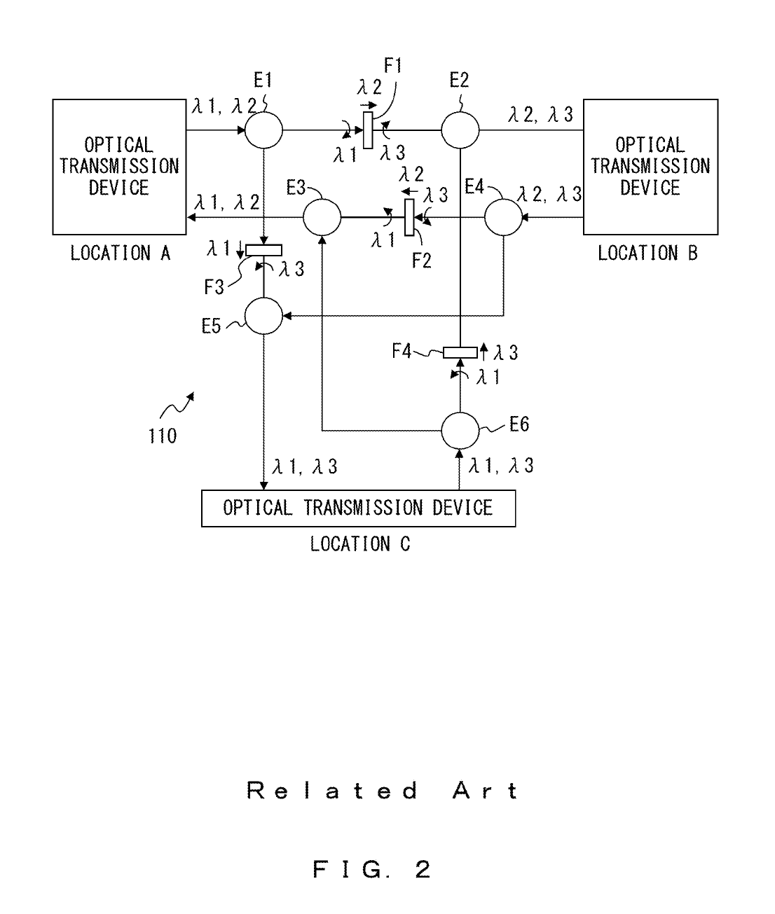

Described below is the effect of the configuration of the embodiment of the present invention. The effect of the configuration according to the embodiment of the present invention is described below with reference to the conventional configuration illustrated in FIG. 2.

In the conventional configuration illustrated in FIG. 2, the wavelength λ2 is allocated to the bidirectional transmission between the locations A and B, the wavelength λ3 is allocated to the bidirectional transmission between the locations B and C, and the wavelength λ1 is allocated to the bidirectional transmission between the locations C and A. Therefore, when a WDM optical signal is branched using this configuration, the wavelength band for a WDM transmission is divided into three wavelength bands. Assume that the bandwidth for the WDM transmission is 36 nm. In this case, the bandwidth which may be allocated to each destination is 12 nm. That is, each optical transmission device is unable to use the band of 12 nm in 36 nm. Therefore, according to the conventional configuration illustrated in FIG. 2, the utilization efficiency of communication resources (wavelength in this example) is low.

In FIG. 2, assume that the optical transmission device at the location A transmits the optical signal λ3 in addition to the optical signals λ1 and λ2. Also assume that the optical filter F3 passes the wavelength λ3. Then, the optical signal λ3 transmitted from the location A is guided by the optical signal switching device 110 to the location C. However, in this case, the optical signal λ3 transmitted from the location A interferes with the optical signal λ3 transmitted from the location B at, for example, the optical circulator ES. Therefore, the optical transmission device at the location A is substantially unable to transmit the optical signal λ3.

On the other hand, in the configuration according to the embodiment illustrated in FIGS. 3 and 7, an arbitrary transmission is realized between the locations A through C using two wavelength bands B1 and B2. For example, the optical transmission device 2A transmits a signal to the location B using the wavelength band B1, and transmits a signal to the location C using the wavelength band B2. As with the example above, it is assumed that the bandwidth for the WDM transmission is 36 nm. In this case, the bandwidth which may be assigned to each destination is 18 nm. That is, each optical transmission device may use all bands for the WDM transmission. Therefore, with the configuration according to the embodiment of the present invention, the utilization efficiency of the communication resources (wavelength in this example) is high.

The effect on the utilization efficiency of communication resources is also obtained when the number of locations supported by the optical transmission system increases. That is, when the conventional configuration illustrated in FIG. 2 is used, for example, five wavelengths are required for a transmission among four locations, and eight wavelengths are required for a transmission among five locations. On the other hand, in the configuration according to the embodiment of the present invention, a transmission among four locations maybe performed using four wavelengths, and a transmission among five locations maybe performed using six wavelengths. Thus, the configuration according to the embodiment of the present invention requires the smaller number of wavelengths (or the number of wavelength bands) comparing with the configuration illustrated in FIG. 2. Therefore, in the configuration according to the embodiment of the present invention, the utilization efficiency of communication resources (wavelength in this example) is high.

Also in the conventional configuration illustrated in FIG. 2, it is necessary to prepare three types of optical filters (which pass λ1, λ2, and λ3). On the other hand, in the configuration according to the embodiment of the present invention, an optical signal switching device may be implemented by two types of optical filters (which pass the wavelength bands B1 and B2) as illustrated in FIG. 7.

Furthermore in the conventional configuration illustrated in FIG. 2, an optical signal may be transmitted using the reflection by the optical filters F1 through F6. Therefore, optical loss may be serious in the optical signal switching device. On the other hand, since an optical signal may be transmitted with a simple configuration according to the embodiment illustrated in FIG. 7, optical loss may be suppressed in the optical signal switching device.

### <Other Configurations>

According to the embodiment above, the split ratio of the optical splitter provided for the optical signal switching device is 1:1, for example. In this case, the optical splitter may be implemented by a 3 dB coupler which equally splits input light. However, the split ratio of the optical splitter is not limited to 1:1. The split ratio of the optical splitter may be determined based on the distance of optical transmission paths.

The transmitter module of an optical transmission device may generate an optical signal using a full-band tunable laser. Furthermore, the receiver module of the optical transmission device may extract an optical signal of a specified wavelength (or wavelength band) using a full-band tunable filter. According to this configuration, an optical transmission device provided at each location may have a general-purpose configuration independent of the number of the locations.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An optical signal switching device used in an optical transmission system which transmits a WDM optical signal including a first wavelength band and a second wavelength band which is allocated at a longer wavelength side with respect to the first wavelength band, the optical signal switching device comprising:
first through third input ports;
first through third output ports;
first through third optical splitters:
first through third optical couplers;
first through third short wavelength pass filters respectively configured to pass the first wavelength band and reject the second wavelength band; and
first through third long wavelength pass filters respectively configured to pass the second wavelength band and reject the first wavelength band, wherein
the first optical splitter splits a WDM optical signal input through the first input port to be guided to the first short wavelength pass filter and the first long wavelength pass filter,
the second optical splitter splits a WDM optical signal input through the second input port to be guided to the second short wavelength pass filter and the second long wavelength pass filter,
the third optical splitter splits a WDM optical signal input through the third input port to be guided to the third short wavelength pass filter and the third long wavelength pass filter,
the first optical coupler combines an output optical signal of the first short wavelength pass filter and an output signal of the third long wavelength pass filter to be guided to the second output port,
the second optical coupler combines an output optical signal of the second short wavelength pass filter and an output signal of the first long wavelength pass filter to be guided to the third output port, and
the third optical coupler combines an output optical signal of the third short wavelength pass filter and an output signal of the second long wavelength pass filter to be guided to the first output port.

2. The optical signal switching device according to claim 1, wherein
a WDM optical signal in which an optical signal transmitted from a first location addressed to a second location is allocated in the first wavelength band and an optical signal transmitted from the first location addressed to a third location is allocated in the second wavelength band is input to the first input port,
a WDM optical signal in which an optical signal transmitted from the second location addressed to the third location is allocated in the first wavelength band and an optical signal transmitted from the second location addressed to the first location is allocated in the second wavelength band is input to the second input port, and
a WDM optical signal in which an optical signal transmitted from the third location addressed to the first location is allocated in the first wavelength band and an optical signal transmitted from the third location addressed to the second location is allocated in the second wavelength band is input to the third input port.

3. An optical transmission system which includes first through third optical transmission devices and an optical signal switching device, and transmits a WDM optical signal including a first wavelength band and a second wavelength band which is allocated at a longer wavelength side with respect to the first wavelength band, wherein
the first optical transmission device generates a WDM optical signal in which an optical signal addressed to the second optical transmission device is allocated in the first wavelength band and an optical signal addressed to the third optical transmission device is allocated in the second wavelength band,
the second optical transmission device generates a WDM optical signal in which an optical signal addressed to the third optical transmission device is allocated in the first wavelength band and an optical signal addressed to the first optical transmission device is allocated in the second wavelength band,
the third optical transmission device generates a WDM optical signal in which an optical signal addressed to the first optical transmission device is allocated in the first wavelength band and an optical signal addressed to the second optical transmission device is allocated in the second wavelength band,
the optical signal switching device comprises:
a first input port optically connected to an optical transmission path which transmits the WDM optical signal generated by the first optical transmission device;
a second input port optically connected to an optical transmission path which transmits the WDM optical signal generated by the second optical transmission device;
a third input port optically connected to an optical transmission path which transmits the WDM optical signal generated by the third optical transmission device;
a first output port optically connected to an optical transmission path which transmits a WDM optical signal toward the first optical transmission device;
a second output port optically connected to an optical transmission path which transmits a WDM optical signal toward the second optical transmission device;
a third output port optically connected to an optical transmission path which transmits a WDM optical signal toward the third optical transmission device;
first through third optical splitters;
first through third optical couplers;
first through third short wavelength pass filters respectively configured to pass the first wavelength band and reject the second wavelength band; and
first through third long wavelength pass filters respectively configured to pass the second wavelength band and reject the first wavelength band, wherein
the first optical splitter splits the WDM optical signal input through the first input port to be guided to the first short wavelength pass filter and the first long wavelength pass filter,
the second optical splitter splits the WDM optical signal input through the second input port to be guided to the second short wavelength pass filter and the second long wavelength pass filter,
the third optical splitter splits the WDM optical signal input through the third input port to be guided to the third short wavelength pass filter and the third long wavelength pass filter,
the first optical coupler combines an output optical signal of the first short wavelength pass filter and an output signal of the third long wavelength pass filter to be guided to the second output port,
the second optical coupler combines an output optical signal of the second short wavelength pass filter and an output signal of the first long wavelength pass filter to be guided to the third output port, and
the third optical coupler combines an output optical signal of the third short wavelength pass filter and an output signal of the second long wavelength pass filter to be guided to the first output port.

4. An optical signal switching device which includes a plurality of optically connected transmission modules, wherein:
each of the transmission modules comprises:
first through third input ports;
first through third output ports;
first through third optical splitters:
first through third optical couplers; and
first through sixth optical filters respectively configured to pass apart of wavelength bands of a WDM optical signal and reject remaining wavelength bands of the WDM optical signal,
in each of the transmission modules:
the first optical splitter splits a WDM optical signal input through the first input port to be guided to the first and second optical filters having different wavelength characteristics,
the second optical splitter splits a WDM optical signal input through the second input port to be guided to the third and fourth optical filters having different wavelength characteristics,
the third optical splitter splits a WDM optical signal input through the third input port to be guided to the fifth and sixth optical filters having different wavelength characteristics,
the first optical coupler combines an output optical signal of the first optical filter and an output optical signal of the sixth optical filter to be guided to the second output port,
the second optical coupler combines an output optical signal of the second optical filter and an output optical signal of the third optical filter to be guided to the third output port, and
the third optical coupler combines an output optical signal of the fourth optical filter and an output optical signal of the fifth optical filter to be guided to the first output port, and
the second input port and the second output port of each transmission module except one specified transmission module in the plurality of transmission modules are optically connected respectively to the first output port and the first input port of a corresponding transmission module.
